(19) United States
(12) Patent Application Publication
(10) Pub. No.: US 2016/0136996 A1
(43) Pub. Date: May 19, 2016

(54) Single Shell Bicycle Hub with Enlarged Drive-Side Flange

(71) Applicants: Robert Sweeting, Asheville, NC (US); Shawn Gravois, Sarasota, FL (US)

(72) Inventors: Robert Sweeting, Asheville, NC (US); Shawn Gravois, Sarasota, FL (US)

(21) Appl. No.: 14/542,643

(22) Filed: Nov. 16, 2014

(51) Int. Cl. B60B 27/02; B60B 27/04; B60B 27/00; B60B 1/00; B60B 1/04

(52) U.S. Cl. CPC B60B 27/023; B60B 1/003; B60B 1/041; B60B 1/042; B60B 27/0026; B60B 27/047; B60B 2360/104; B60B 2900/321; B60B 2900/10

(57) ABSTRACT

A single shell bicycle wheel hub described herein facilitates improved performance and reduced energy loss. A rear hub assembly includes a single shell that forms a non-drive-side spoke flange and a drive-side spoke flange. The drive-side flange is enlarged relative to the non-drive-side flange thereby improving the angle of the spoke attachment to the hub and facilitating more even spoke tensioning. For example, a drive-side flange diameter is at least 100 mm. The flanges are optionally tilted toward a wheel center line to more directly align the flange and spoke holes with the assembled spokes. The single shell hub is formed so as to receive three sets of bearings with two of the three sets of bearings mounted near the center line of the hub assembly.

### BACKGROUND

1. Field

The present invention relates generally to bicycles, and more particularly, to a wheel assembly and a hub or hub assembly for bicycle wheels and similar type wheels.

2. Related Art

Bicycles are machines designed to translate energy in human muscles into translational movement. Cyclists have a limited supply of energy, and therefore it is desirable to design a bicycle to be as efficient as possible. In a conventional bicycle, the hub of the rear wheel is the location where a linear mechanical force from a chain is translated into a rotational movement. Even small amounts of flexing and movement that is not translated into a forward translational movement results in wasted energy. Hubs are made of many various components including a hub shell that rotates about an axle, bearings, threaded nuts, and various parts making up a freewheel mechanism. The interaction of the various hub and wheel components can result in wasted energy. Even small savings can translate into more speed or more endurance for the rider. Accordingly, there is an opportunity to improve upon existing wheel and hub components to make a more durable and efficient bicycle.

### SUMMARY

Embodiments and techniques described herein relate to a single shell bicycle wheel hub. The hub provides benefits and advantages not previously available in other implementations.

In one particular illustrative implementation, a hub assembly includes a one-piece hub shell. The one-piece hub shell provides for improved stiffness and minimizes weight of the overall hub assembly.

An improved, enlarged drive-side flange provides a means for improved spoke arrangements and better spoke geometries including formation of a better angle for the dish of a rear wheel assembly. The enlarged drive-side flange enables a larger effective triangular base—the distance between a wheel centerline and spoke heads along a rim. The enlarged drive-side flange allows the drive-side spokes to more closely match the geometry of the non-drive-side spokes, and allows for substantially similar tension in the drive-side spokes as compared with the tension in the non-drive-side spokes. The flanges may be formed with an internal tilt such that they do not extend directly perpendicular to the axis of rotation of the axle at the point of spoke attachment to provide for improved translation of energy and reduce the possibility for breaking spokes at the point of attachment.

This Summary is provided to introduce a selection of concepts in a simplified form that are further described below in the Detailed Description. This Summary is not intended to identify key or essential features of the claimed subject matter, and thus is not intended to be used to limit the scope of the claimed subject matter.

### BRIEF DESCRIPTION OF THE DRAWINGS

While the appended claims set forth the features of the invention with particularity, the invention, together with its objects and advantages, is more readily appreciated from the following detailed description, taken in conjunction with the accompanying drawings. Throughout, like numerals generally refer to like parts. Unless specifically indicated, the components and drawings are not shown to scale.

FIG. 1 is a perspective view of a single shell hub assembly with an enlarged drive-side flange according to a first illustrated embodiment.

FIG. 2 is a cross-sectional view of the single shell hub assembly shown in FIG. 1.

FIG. 3 is a front view of the hub shell shown in FIG. 2.

FIG. 4 is a front view of various components of a wheel according to a first illustrated embodiment.

### DETAILED DESCRIPTION

Overview. Whether in competitive sports or in recreational riding, bicycle wheels are of significant interest because the wheels and hubs are places where rotational motion and translational motion are involved. Flexing, friction and wear can reduce operational efficiency and performance. In particular, rear hubs are typically the place where human energy is translated into motion. One of the difficulties in designing, manufacturing and assembling rear hubs is the design choice to place a set of gears to engage with the rear hub. The gears are typically mounted on the right side of the wheel making it the drive side where a chain translates pedaling of crank arms into rotational force at the rear hub. Typically, this arrangement requires that the drive-side flange is in moved toward the center line of the axle. This offset often requires that the drive-side spokes be given a higher tension. Higher tension and changed geometry is one source of wear, friction and non-ideal performance of rear hubs. The instant invention solves many of the shortcomings of current designs.

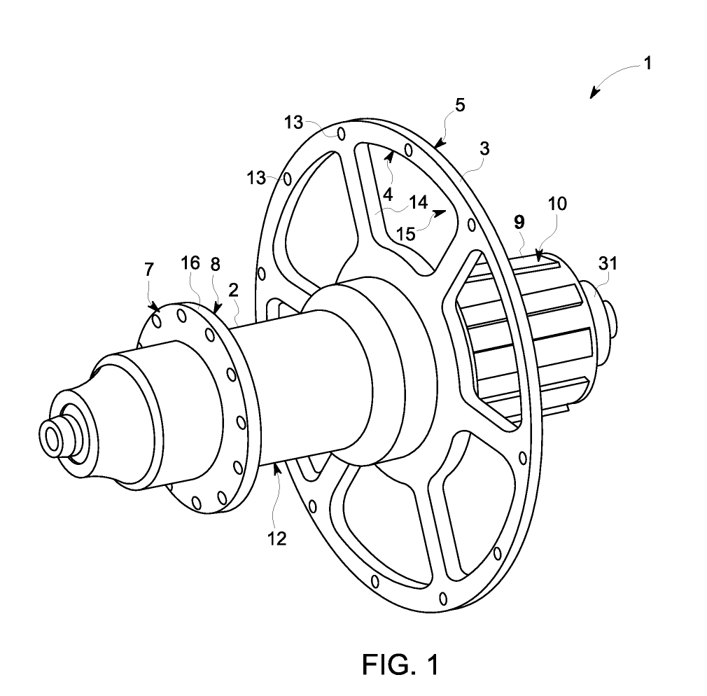

FIG. 1 is a perspective view of a single shell hub assembly for a rear wheel or drive wheel according to the instant invention. The overall hub assembly is generally designated as 1. The hub 1 is for use with or as part of a wheel assembly that generally includes a tire, a rim, spokes, and spoke nipples, and these components are not shown in FIG. 1 for the sake of simplicity in illustrating the invention. A drive wheel assembly also may include other parts such as a securing mechanism, spacers, and a gear or set of gears.

With reference to FIG. 1, the single shell hub assembly 1 includes a hub shell 2 that includes a top surface 12 and an inner surface (not labeled). The top surface 12 may be painted, powder coated, anodized and the like. The top surface may be branded with a particular logo, coloring or other distinguishing features.

The hub assembly 1 includes a drive-side flange 3 and a non-drive-side flange 6. The single shell hub assembly preferably includes an enlarged drive-side flange according to a first embodiment. The drive-side flange 3 has a first side 4 and a second side 5. The first side 4 lies toward an inside portion of an assembled wheel. The drive-side flange 3 includes a set of spoke holes 13 or spoke attachment points. While twelve spoke holes 13 are shown, other numbers of spoke holes (and corresponding number of spokes) may be used to assembly a wheel. Not every spoke hole 13 is required to be used when a wheel assembly is built with the hub assembly 1. For example, a wheel may be built with just six drive-side spokes. Accordingly, a varying number of spoke holes 13 may be made depending on production considerations to meet a variety of uses and spoking requirements by end users. The spoke holes 13 are shown uniformly distributed distally along a circumference at a same distance from the center axis of the hub 1. However, this is not required. Further, the spoke holes 13 are not required to be uniformly distributed along a circumference, but are shown in FIG. 1 as being uniformly distributed. The drive-side flange 3 may be formed with ribs 14 which are separated from one another by gaps, voids or apertures 15. The apertures 15 reduce the overall weight of the drive-side flange 3 and hub 1. Depending on the method of manufacture, forming ribs 14 and apertures 15 in the drive-side flange may increase the cost of production, but provides increased benefits in performance (e.g., increased acceleration, reduction in friction), responsiveness, aesthetics, etc. While the ribs 14 and apertures 15 are shown as uniformly distributed, such symmetry is not required.

The non-drive-side flange 6 has a first side 7 and a second side 8. The non-drive-side flange 6 includes a set of spoke holes 16 or spoke attachment points. While twelve spoke holes 16 are shown, other numbers of spoke holes (and corresponding number of spokes) may be used. Not every spoke hole 16 is required to be used when a wheel assembly is built with the hub assembly 1. The spoke holes 16 are shown uniformly distributed distally in the non-drive-side flange 6 at a same distance from the center axis of the hub 1. However, this is not required. Further, the spoke holes 16 are not required to be uniformly distributed along a circumference of the non-drive-side flange 6. The non-drive-side flange 6 is shown as generally solid. In other embodiments, the non-drive-side flange 6 may also include voids or apertures such as those shown in the drive-side flange 3. However, it is desirable to have the drive-side flange 3 and the non-drive-side flange 6 be of different sizes in diameter, as explained further herein. For example, an enlarged drive-side flange 3 provides improved spoke geometry on the drive side.

The hub assembly 1 includes a freewheel body 9 that has an outer surface 10. The outer surface or portion 10 may include grooves, ribs or splines to accommodate a gear set or gear cassette (not shown in FIG. 1 for simplicity). The hub assembly 1 also includes an axle 31 and an end cap or lock nut 11. The freewheel body 9 and other components of the hub assembly 1 are described in further detail herein.

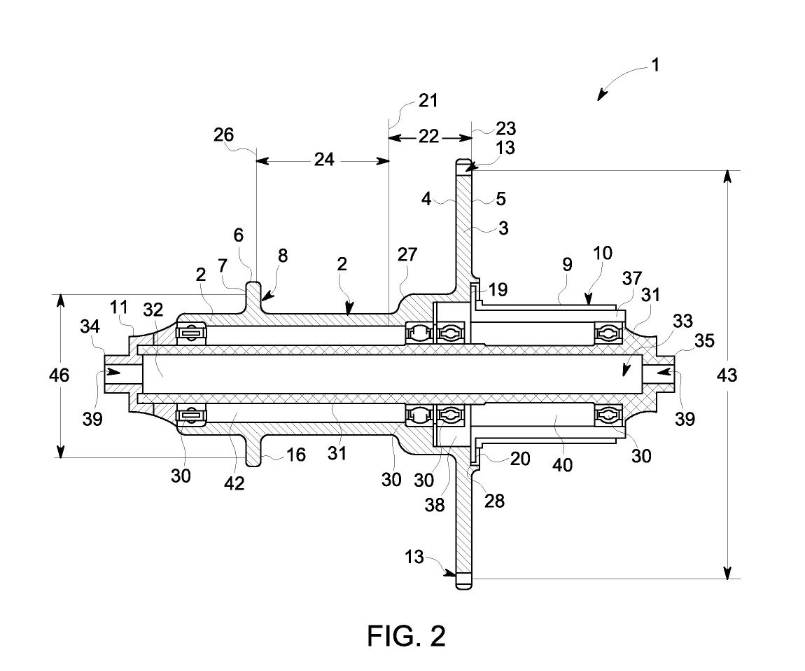

FIG. 2 is a cross-sectional view of the single shell hub assembly shown in FIG. 1. While FIG. 2 shows further components and details with respect to the hub assembly 1, not all components and features of the hub assembly are shown for the sake of simplicity and illustration only. Certain additional features and details are only described herein in relation to FIG. 2. With reference to FIG. 2, the hub assembly 1 includes a hub shell 2 and freewheel body 9. The freewheel body 9 includes an outer surface 10. The freewheel body 9 may include splines 37 for accepting and engaging with a cassette of gears such as a set of ten or eleven or other number of gears for a multi-geared rear wheel. For example, the assembly 1 may be Shimano® compatible and Campagnolo® compatible when manufactured. The freewheel body 9 also includes a ratcheting portion 38 that engages in the proximal end of the hub shell 2. The ratcheting portion 38, although not shown in complete detail in FIG. 2, includes pawls, springs and teeth. In one implementation, the ratcheting mechanism includes a set of teeth or ratchet ring 38 that is threaded into the proximal side of the hub shell 2. In such an arrangement, the pawls and springs of the ratchet mechanism are mounted or threaded inside the freewheel body 9. The pawls of the freewheel body 9 interact with the ratchet ring. According to a preferred implementation, a six-pawl configuration is used and leaf springs are used for the actuation of the pawls. A six-pawl configuration can provide more reliable engagement, is less likely to slip, and allows for quicker engagement. An axle 31 includes a long tubular body that passes through the hub shell 2 and through the freewheel body 9. The hub shell 2 and the freewheel body 9 rotate about the axle 31 when the hub assembly 1 is in operation.

With reference to FIG. 2, an end cap or lock nut 11 fits onto the distal end 32 of the axle 31. While teeth are not shown, the lock nut 11 is threaded so as to engage with and fit onto a threaded portion of the distal end 32 of the axle 31. The proximal end 33 of the axle 31 may be formed so as to match aesthetically or mechanically the shape and dimensions of the lock nut 11. The lock nut 11 has a protrusion 34 for mating with a slot in the frame of a bicycle (not shown). The proximal end 35 of the axle 31 also has a protrusion 35 for the same purpose. According to one implementation, the axle 31 may take the form of a dual lock nut axle width fixing setup. As shown, the axle 31 and lock nut 11 are hollow. That is, these components provide a void or passage 39 through which a quick release rod (not shown) passes for securing the axle 31 to the bicycle frame. While not shown, lock nuts may be used such that a dual locking arrangement may be used to assemble the hub assembly 1 shown in FIG. 2.

The drive-side flange 3 includes spoke holes 13 that pass from a first side 4 to a second side 5. The non-drive-side flange 6 includes spoke holes 16 that pass from a first side 7 to a second side 8. Spokes (not shown) may be mounted from either side 4, 5 in a finished wheel assembly.

The proximal side of the hub shell 2 includes a shoulder 27 that enlarges the outer diameter of the hub shell 2 to accommodate bearings 30 in the inner portion of the hub shell 2. Three sets of bearings 30 are shown in the hub shell 2—one set of bearings toward the distal end 32 of the hub shell 2, and two sets of bearings 30 toward the proximal end of the hub shell. Two sets of bearings 30 are mounted in the proximal end of the hub shell 2 to provide increased stability to the hub assembly 1 during operation (i.e., riding of the bicycle, turning of the wheel). As shown, the two sets of bearings 30 are mounted near the midline 21 of the hub assembly 1. There is a fourth set of bearings 30 at the distal end of the freewheel body 9—the end closest to the proximal end 35 of the axle 31. According to an illustrative embodiment, the bearings have a 15 mm inner diameter (ID) and a 26 mm outer diameter (OD).

In the implementation shown in FIG. 2 there are four sets of bearings 30. A three bearing set, a five bearing set and other number of bearings also contemplated within the scope of the teachings of the invention. Other types, styles and numbers of bearings may be used in conjunction with the other components described herein. The particular arrangement of axle 31, bearings 30 and other components helps ensure that the bearings 30 do not bind from side loading. Further, this arrangement prevents the axle 31 from moving side to side in a completed hub assembly 1, making the hub assembly 1 more durable as compared to previous designs due to less bearing wear. A one piece axle 30 prevents torquing and binding of bearings 30. In a preferred implementation, bearing seals do not touch the ball bearings allowing the bearings to spin as freely as possible. The bearings 30 preferably are made with a labyrinth-style seal to keep contaminants out. If making a non-drive hub assembly, only two bearings 30 would be needed since no freewheel body 9 and gears would not be used or included.

With reference to FIG. 2, the drive-side flange 3 is formed a first distance 22 from the midline 21 as indicated by a vertical line 23. The first distance 22 is measured from the center line 21 to a position of the spoke hole 13 in the drive-side flange 3. The non-drive-side flange 6 is formed a second distance 24 from the midline 21 as indicated by another vertical line 26. The second distance 24 is measured from the center line 21 to a position of the spoke hole 16 in the non-drive-side flange 6. Spokes (not shown) for the drive-side flange 3 are mounted in the spoke holes 13 and are mounted to a rim (not shown) at a point generally near the center line or midline 21. Spokes for the non-drive-side flange 6 are mounted in the spoke holes 16 and also are mounted to the rim at a point generally near the center line or midline 21. According to the geometry of the hub assembly 1, the drive-side spokes may be shorter than the non-drive-side spokes depending on the spoke configuration selected when a wheel is built and depending on the size of the enlarged drive-side flange. Because of the geometry, the spokes on the non-drive side and the spokes on the drive side may be tensioned the same or approximately the same when a wheel is built. According to an illustrative build, twenty four spokes are used with a 12×3 cross spoke lacing on the non-drive side, and a 12× radial spoke lacing on the non-drive side. Such a spoking offers improved energy transfer, responsiveness and operation of a rear wheel assembly. Other spoking arrangements are possible.

In one implementation, the first (drive-side) distance 22 is approximately 19 mm, and the second (non-drive-side) distance 24 is approximately 33 mm. As for the axle, the axle 31 has an outer diameter of approximately 15 mm, and an inner diameter of approximately 10 mm. Other measurements are possible. However, these measurements were found to be one implementation for optimal performance, strength, weight, and dish or shape of an assembled wheel or drive wheel. In terms of construction materials, as one example, the hub shell is made of a 6069-T6 aluminum, and the axle and lock rings are made of a 7075-T6 aluminum. As another example, the hub shell is made from a series 6000 aluminum alloy. The drive-side and non-drive-side flanges 3, 6 have a width or thickness of approximately 3.5 mm.

In the implementation shown, the non-drive-side flange 6 is smaller in diameter 46 than the diameter 43 of the drive-side flange 3. The diameters 43, 46 may be measured in various ways. One way of measuring references the center of opposing spoke holes 13, 16. In one implementation, the drive-side diameter 43 is preferably at least 110 mm, and the non-drive-side diameter 46 is about 38 mm. These dimensions, and the configuration of the various elements, provide significant lateral stiffness and reduced weight as compared to conventional designs.

With reference again to FIG. 2, the freewheel body 9 includes a lip 19 that abuts the second side 5 of the drive-side flange 3. The second side of the drive-side flange 3 includes a shoulder 28 that protects the edge or lip 19 of the freewheel body 9. The freewheel body 9 may include a ring 20 or other elements to prevent moisture and debris from interfering with the operation and mechanism of the freewheel body 9. Given the arrangement of the various components, the hub assembly 1 may include a void 40 between the axle 31 and the outer surface of the freewheel body 10. A void 42 also may be found between the hub body 2 and the shaft of the axle 31.

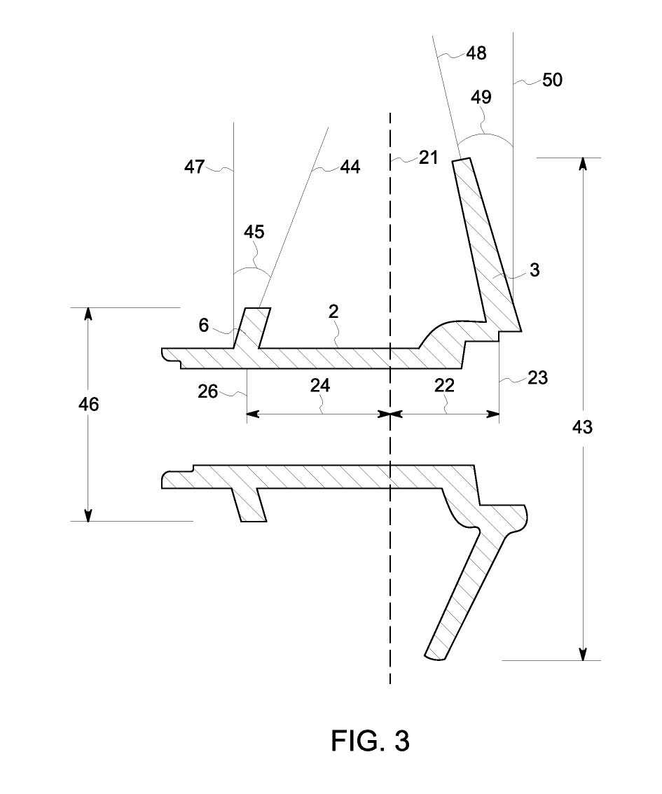

FIG. 3 is a front view of the hub shell shown in FIG. 2. With reference to FIG. 3, a hub includes a drive-side flange 3 that lies generally along a drive-side flange line 48 that is tilted a drive-side angle 49 away from a vertical reference 50 that lies perpendicular to an axis that runs through the center of the hub shell. In an illustrative example, the tilt drive-side angle 49 is approximately three degrees as measured relative to a reference line extending perpendicular to the axle and with a line drawn through a point of origin or base point of the flange on the hub shell and a central point of a spoke hole in the periphery of the spoke flange. The base of the drive-side flange 3 starts approximately at a first distance 22 from the midline 21 as indicated by a vertical line 23. A non-drive-side flange 6 lies generally along a non-drive-side flange line 44 that is tilted a non-drive-side angle 45 away from a vertical reference 47. In an illustrative example, the tilt non-drive-side angle 47 is approximately three degrees. The base of the non-drive-side flange 6 starts approximately at a second distance 24 from the midline 21 as indicated by a second vertical line 26. The drive-side angle 49 used may depend on a size of the drive-side diameter 43 or other factors or conditions such as the diameter of the wheel to which the hub belongs. Similarly, the non-drive-side angle 45 used may depend on a size of the non-drive-side diameter 46 or other factors or conditions such as a ratio of the first flange distance 22 relative to the second flange distance 24.

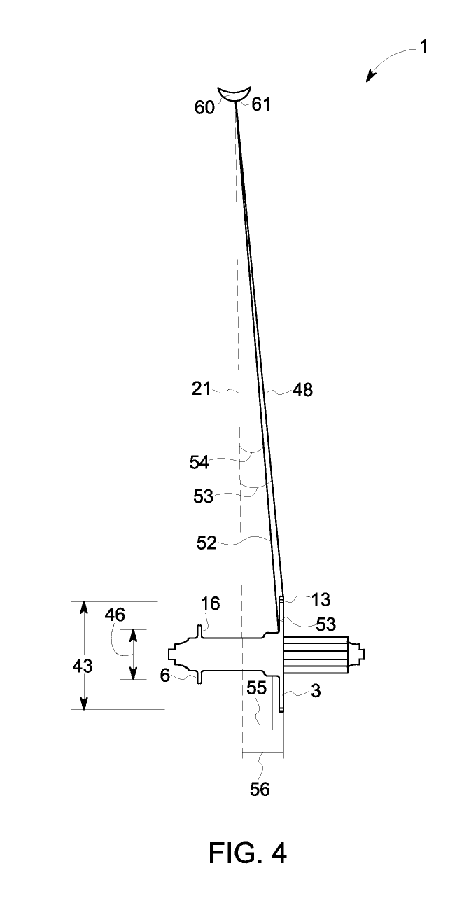

FIG. 4 is a front view of various components of a wheel according to a first illustrated embodiment. With reference to FIG. 4, a rim portion 60 is shown above the midline 21 of a rear hub assembly 1. A first spoke 48 is shown for comparison against the geometry and arrangement of a second spoke 52 both of which are shown mounted at a single spoke mount location 61. The first spoke 48 is mounted to an appropriate, designated spoke hole 13 near the periphery of an enlarged drive-side flange 3. As is visible, the first spoke 48 is substantially shorter than the second spoke 52. The second spoke 52 is mounted on the drive-side flange 3 at an equivalent location corresponding to the spoke hole 16 of the non-drive-side flange 6 to illustrate differences between a conventional sized 46 drive-side flange and an enlarged flange. As is visible, a first drive-side spoke-mount angle 53 for an enlarged flange 3 of size 43 is substantively greater than if the flange 3 were of a conventional size 46 and conventional drive-side angle 54. It is noted that neither the conventional drive-side angle 54 nor the enlarged flange drive-side angle 53 are required to match with the tilt angles 45, 49 of either the non-drive-side flange and drive-side flange shown in FIG. 3. In an illustrative implementation, the drive-side angle 53 is approximately five degrees, and a corresponding non-drive-side angle is approximately eleven degrees.

The tension in the second spoke 52 would likely be substantially greater if mounted as shown in FIG. 4 as compared to the tension in the first spoke 48. Thus, FIG. 4 illustrates some of the advantages of an enlarged drive-side flange 3 according to the teachings of the instant invention. For example, the triangle base 56 provided by the enlarged flange 3 is substantially larger than the triangle base 55 of a conventional sized drive-side flange. The triangle base is defined here as, for example, the distance from a center line 21 and a spoke head attachment point on a flange. The geometry provided by the enlarged drive-side flange 3 allows for the drive-side spokes to be tensioned the same or similarly as those on the non-drive-side while still providing for an effective rear wheel dish. The one piece shell design enables lateral stiffness and minimal weight compared to conventional designs.

Conclusion. In the previous description, for purposes of explanation, numerous specific details are set forth in order to provide an understanding of the invention. It will be apparent, however, to one skilled in the art that the invention can be practiced without these specific details. In other instances, structures, devices, systems and methods are shown only in block diagram form in order to avoid obscuring the invention.

Reference in this specification to “one embodiment”, “an embodiment”, or “implementation” means that a particular feature, structure, or characteristic described in connection with the embodiment or implementation is included in at least one embodiment or implementation of the invention. Appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It will be evident that the various modification and changes can be made to these embodiments without departing from the broader spirit of the invention. In this technology, advancements are frequent and further advancements are not easily foreseen. The disclosed embodiments may be readily modifiable in arrangement and detail as facilitated by enabling technological advancements without departing from the principles of the present disclosure.

We claim:

1. A bicycle hub assembly comprising:
a hub shell extending along a central axis, wherein the hub shell includes:
an outer surface,
an inner surface that defines an axial passage,
a non-drive-side spoke flange having a first flange diameter, and
a drive-side spoke flange having a second flange diameter, and wherein the second flange diameter is at least two times larger than the first flange diameter;
an axle inserted in the axial passage defined by the hub shell and which is coaxial to the central axis; and
a freewheel body affixed on the drive-side of the hub shell and through which the axle is inserted.

2. The bicycle hub assembly of claim 1, wherein the axle includes a proximal end and a distal end, and wherein the proximal end is formed in the shape of an end cap, and wherein the distal end is threaded so as to be capable of receiving a threaded end cap.

3. The bicycle hub assembly of claim 1, wherein the bicycle hub assembly further comprises four sets of bearings, and wherein the inner surface of the hub shell is formed so as to be able to receive three of the four sets of bearings inside of the hub shell, and wherein three of the four sets of bearings are mounted inside of the hub shell, and wherein the other set of bearings is mounted on the axle and in the freewheel body.

4. The bicycle hub assembly of claim 1, wherein the second flange diameter is at least 100 mm.

5. The bicycle hub assembly of claim 1, wherein the non-drive-side spoke flange includes a set of spoke holes, and wherein the non-drive-side spoke flange is tilted inward at least two degrees toward a wheel centerline as measured from a flange line drawn from a point of origin of the non-drive-side spoke flange on the outer surface of the hub shell through a center point of a spoke hole in the non-drive-side spoke flange.

6. The bicycle hub assembly of claim 1, wherein the drive-side spoke flange includes a set of spoke holes, and wherein the drive-side spoke flange is tilted inward at least two degrees toward a wheel centerline as measured from a flange line drawn from a point of origin of the drive-side spoke flange on the outer surface of the hub shell through a center point of a spoke hole in the drive-side spoke flange.

7. The bicycle hub assembly of claim 1, wherein the drive-side spoke flange includes spoke holes, and wherein the hub assembly further comprises:
a rim; and
a set of spokes mounted radially in the spoke holes and to the rim.

8. The bicycle hub assembly of claim 7, wherein the non-drive-side spoke flange includes non-drive-side spoke holes, and wherein the hub assembly further comprises a set of spokes mounted in a three-cross pattern in the non-drive-side spoke holes and to the rim.

9. The bicycle hub of claim 1, wherein the hub shell is made of 6069-T6 aluminum.

10. The bicycle hub of claim 1, wherein the freewheel body includes ratchet teeth and six pawls.
